(19) United States
(12) Patent Application Publication
(10) Pub. No.: US 2024/0205573 A1
(43) Pub. Date: Jun. 20, 2024

(54) EARPHONE ASSEMBLY

(71) Applicant: Shenzhen Quanzhi Information Technology Co., Ltd., Shenzhen (CN)

(72) Inventors: Jingjing WANG, Shenzhen (CN); Yunping TIAN, Shenzhen (CN)

(21) Appl. No.: 18/223,589

(22) Filed: Jul. 19, 2023

(30) Foreign Application Priority Data
Dec. 14, 2022 (CN) 202223370238.2
Dec. 14, 2022 (CN) 202223376466.0
Dec. 14, 2022 (CN) 202223392504.1
Dec. 14, 2022 (CN) 202223393549.0

(51) Int. Cl. H04R 1/02; H04R 1/10

(52) U.S. Cl. CPC H04R 1/02; H04R 1/1016

(57) ABSTRACT

Disclosed is an earphone assembly, which is related to a technical field of earphone, comprising an earphone case, the earphone case comprises an earphone opening and closing component, an earphone placement component and a connection component, the earphone opening and closing component and the earphone placement component are detachably connected by the connection component.

### CROSS-REFERENCE TO RELATED APPLICATION

This application claims the priority and benefit of Chinese patent application serial no. 202223376466.0, filed on Dec. 14, 2022, Chinese patent application serial no. 202223370238.2, filed on Dec. 14, 2022, Chinese patent application serial no. 202223392504.1, filed on Dec. 14, 2022 and Chinese patent application serial no. 202223393549.0, filed on Dec. 14, 2022. The entireties of Chinese patent application serial no. 202223376466.0, Chinese patent application serial no. 202223370238.2, Chinese patent application serial no. 202223392504.1, and Chinese patent application serial no. 202223393549.0 are hereby incorporated by reference herein and made a part of this specification.

### TECHNICAL FIELD

This application relates to a technical field of earphone, and, in particular, to an earphone assembly.

### BACKGROUND

A wireless Bluetooth earphone is usually charged under a non-use state when being placed in an earphone case. The current earphone case includes an upper shell and a lower shell, the upper shell and the lower shell shall be able to achieve the function of opening and closing, and shall have a better handle for opening and closing. The earphones are generally placed in the lower shell.

However, the upper shell and the lower shell of the available earphone case are connected together by a hinge, wherein two parts of the hinge are respectively fastened on the upper shell and the lower shell. But when we open the earphone case to take out the earphones, the upper shell will hinder us from taking out the earphones as the upper shell and the lower shell are connected together by the hinge.

For the above-mentioned related technology, there is a problem that it is not easy to take out earphones from the earphone case.

### SUMMARY

In order to improve the problem that it is not easy to take out earphones from the earphone case, an earphone assembly is disclosed.

The following technical solution is adopted by the earphone assembly disclosed:

An earphone assembly including an earphone case, the earphone case includes an earphone opening and closing component of earphone, an earphone placement component and a connection component, the earphone opening and closing component and the earphone placement component are detachably connected by the connection component.

In an embodiment of the present application, the pattern layer is one or a combination of both of a three-dimensional texture, a reflective portion.

In summary, at least one of the following beneficial technical effects is achieved:

1. When an earphone shall be taken out from the earphone case, because the earphone opening and closing component is detachably connected with the earphone placement component by the connection assembly, it is possible to separate the earphone opening and closing component and the earphone placement component to be independent of each other, such that the earphone can be taken out from the earphone placement component more conveniently, which improves the problem that it is not easy to take out earphones from the earphone case.

2. When the earphone opening and closing component is cooperated with the earphone placement component, the insertion block at the earphone slotted plate and the insertion slot at the earphone slotted shell can cooperate with each other, to limit the earphone opening and closing component and the earphone placement component, so that the earphone opening and closing component and the earphone placement component are accurately positioned to each other, and the cooperation of the insertion slot and the insertion block can effectively prevent the earphone opening and closing component and the earphone placement component from shaking.

3. When the earphone opening and closing component and the earphone placement component are clasped, the earphone opening and closing component can cover the earphone placement component in any direction because of the central symmetry of the earphone slotted plate.

4. The first adsorption part is arranged in the insertion block, while the second adsorption part is arranged at the bottom of the insertion slot in the earphone slotted shell, so that a tight clasp between the earphone opening and closing component and the earphone placement component is realized through the mutual attraction of the first adsorption part and the second adsorption part.

5. When the earphones are put into the earphone case for charging, the third adsorption part in the earphone slotted shell can adsorb the earphones, which improves the stability of the earphones in the earphone case and effectively prevents the earphones from falling out of the earphone case during opening the case.

6. The first battery is arranged in the earphone opening and closing component, and the second battery is arranged in the earphone placement component. Multiple batteries are provided, such that battery capacity is increased, thus the endurance of the earphones is improved.

7. The outer surface of the earphone opening and closing component near the earphone placement component is provided with an observation zone, which can provide convenience for the user to check the placing status and charging status of the earphone at any time, such that the user can timely find out whether the earphone is normally charged, meanwhile it can be prevented that the user can't timely notice loss of the earphone, thus reducing the loss risk of the earphones.

8. The elastic supporter is arranged on the second case, the elastic supporter is configured to be deformable to fit the ear arc of a wearer. The elastic supporter can increase the contact area between the earphone and the ear of the wearer, thereby increasing the friction, such that the earphone is not prone to fall off the ear to be damaged, thus the earphone is further fixed at the ear, improving the practicality of the earphone.

9. The surface of the second case is covered with a sound insulation layer. The sound insulation layer covers the surface of the second shell, so that the sound inside the earphone is not easy to transmit out of the earphone, thereby the sound inside the earphone can be conducted to the ear maximally, to ensure clear sound of the earphones.

10. The ear plug is sleeved on the sound hole, such that the earphone sound is conducted to the ear maximally. At the same time, a part of external sound is prevented from entering into the ear, thus lowering the sound of the earphone during using, to protect the audition.

11. The case is provided with a pattern layer to improve the aesthetics of the case, and the pattern layer is covered with a protective layer with a transparent zone, so that the pattern layer is presented, meanwhile it is ensured that the pattern of the pattern layer will not be rubbed off and patchy. The three-dimensional texture on the pattern layer does not come into direct contact with the ear, preventing foreign body feeling and uncomforting when wearing earphones. The protective layer fits directly with the ear to improve the comfort of the user when wearing the earphones, and to protect the pattern layer from discoloring and being patchy, such that it is overcome that the earphone case tends to be damaged and get old, thereby the earphones are maintained as good as new even after a long time use.

12. The circuit layer is encapsulated outside of the case, to provide more space inside the case, which is more convenient for designers to modify the shape of the earphones, so that the earphone can fit more closely into the ear to improve the comfort during wearing, which also reduces the shaking of the circuit layer inside the case that leads to a shortening life of the earphone, thereby prolonging the life of the earphones.

13. The light-emitting component is electrically connected to the circuit layer and is arranged on the side of the circuit layer near the surface layer. The light-emitting component can detect whether the circuit layer works normally. The user can detect whether the earphone is damaged and determine the specific damaged part in time. The light-emitting component can also illuminate the circuit layer, such that the visual effect of the earphone is more unique.

### BRIEF DESCRIPTION OF THE DRAWINGS

FIG. 1 is an exploded view of an earphone assembly according to embodiment 1 of the present application.

FIG. 2 is a section view of the earphone assembly according to embodiment 1 of the present application.

FIG. 3 is an oblique view of front side of the earphone assembly according to embodiment 1 of the present application.

FIG. 4 is an oblique view of back side of the earphone assembly according to embodiment 1 of the present application.

FIG. 5 is an overall structure diagram of an earphone according to embodiment 3 of the present application.

FIG. 6 is a section view along AA direction in FIG. 5.

FIG. 7 is a schematic view of the case film structure of an earphone according to embodiment 4 of the present application.

FIG. 8 is a schematic top view of the earphone according to embodiment 4 of the present application.

### DESCRIPTION OF THE EMBODIMENTS

The present disclosure will be described in detail below in combination with the drawings of the present disclosure.

An earphone assembly is disclosed by embodiments of the present disclosure, including an earphone case 10 and earphones 20 adapted to the earphone case 10.

### Embodiment 1

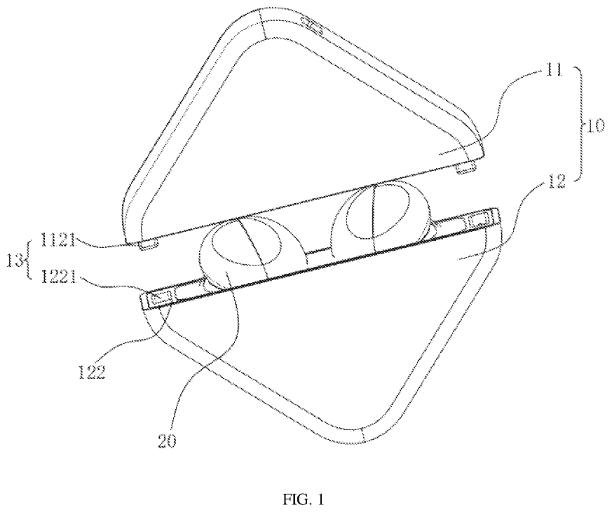

Referring to FIG. 1, the earphone case 10 includes an earphone placement component 12, an earphone opening and closing component 11 and a connection component 13. The earphone opening and closing component 11 and the earphone placement component 12 can be triangular, square etc. in shape. Now take a triangular earphone opening and closing component 11 and earphone placement component 12 as an example, the earphone opening and closing component 11 and the earphone placement component 12 are triangular as a whole. The earphone opening and closing component 11 is detachably connected with the earphone placement component 12 by the connection component 13.

When the earphones shall be taken out from the earphone case, since the earphone opening and closing component 11 is detachably connected with the earphone placement component 12 by the connection component 13, the earphone opening and closing component 11 and the earphone placement component 12 can be detached to be independent of each other, such that the earphones can be easily taken out from the earphone case. Since the earphone opening and closing component 11 and the earphone placement component 12 are independent of each other, the earphone opening and closing component 11 and the earphone placement component 12 can also be easily to clasp. Thus, the problem that the earphones are not easily taken out from the earphone case is improved.

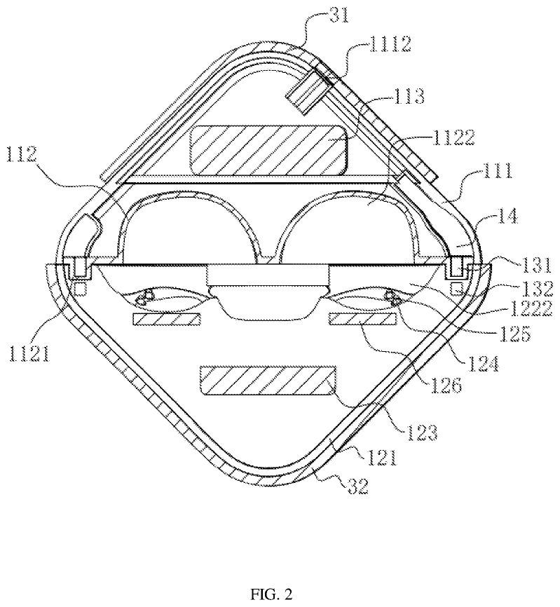

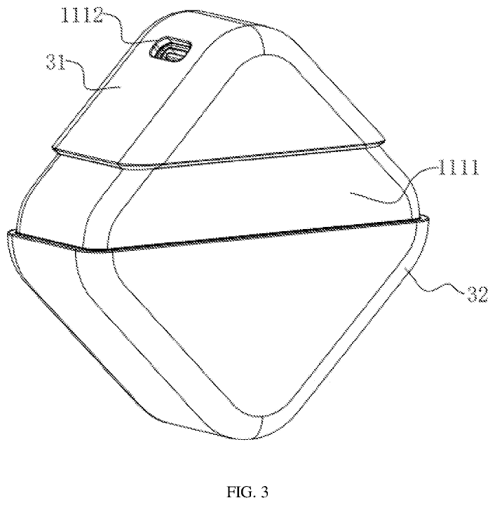

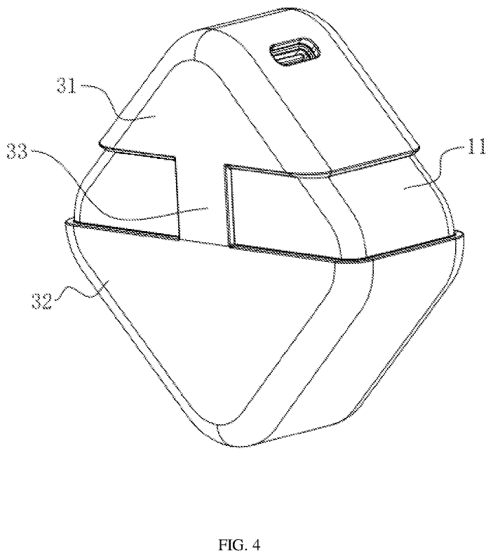

Specifically, referring to FIG. 2, the earphone opening and closing component 11 includes a first protective housing 111 and an earphone slotted plate 112, the earphone slotted plate 112 is a centrosymmetric rectangle in shape. Due to the symmetric structure of the earphone slotted plate 112 and the fact that the space in the slot of the first earphone slot 1122 is larger than the portion of the earphone to be wrapped, it is possible to cover the earphone placement component 12 with the earphone opening and closing component 11 in any direction.

The earphone slotted plate 112 is fastened on the bottom of the first protective housing 111. The earphone slotted plate 112 is provided with two first earphone slots 1122 for wrapping the upper surface of the earphones 20, wherein the first earphone slot 1122 is opened downward. The two first earphone slots 1122 are located on two sides of the symmetrical center of the earphone slotted plate 112, wherein the space in the slot of the first earphone slot 1122 is larger than the portion of the earphone to be wrapped.

The earphone placement component 12 includes a second protective housing 121 and an earphone slotted shell 122.

The earphone slotted shell 122 is fixed to the second protective housing 121. The second protective housing 121 and the earphone slotted shell 122 both are triangle in shape as a whole. A side of the earphone slotted shell 122 facing the earphone opening and closing component 11 is provided with second earphone slots 1222 for accommodating the earphones 20. The first earphone slot 1122 and the second earphone slot 1222 are cooperated with each other to wrap the earphone 20 completely.

Referring to FIG. 2, the connection component 13 includes an insertion block 1121 and an insertion slot 1221 configured to be engaged with insertion block 1121 adaptively. The insertion block 1121 is arranged on the side of the earphone slotted plate 112 facing the earphone placement component 12, while the insertion slot 1221 is arranged on a side of the earphone slotted shell 122 facing the earphone opening and closing component 11. The insertion block 1121 and the insertion slot 1221 each have a shape of a strip-shaped rectangle.

Further, the connection component 13 includes a first adsorption part 131 and a second adsorption part 132. The first adsorption part 131 and the second adsorption part 132 have adsorption force attracting each other. Preferably, both the first adsorption part 131 and the second adsorption part 132 are magnets. The first adsorption part 131 is arranged in the insertion block 1121, while the second adsorption part 132 is arranged in the earphone slotted shell 122 and near the bottom of the insertion slot 1221.

The earphone opening and closing component 11 and the earphone placement component 12 are clasped by magnetic adsorption and engagement. When an earphone in the earphone case shall be taken out, the earphone opening and closing component 11 and the earphone placement component 12 of the earphone case can be separated only by pulling out the earphone opening and closing component 11. Since the earphone opening and closing component 11 and the earphone placement component 12 are separated from each other, the earphone can be easily taken out from the earphone slotted shell 122 of the earphone placement component 12 without obstruction of the earphone opening and closing component 11, which improves the problem that the earphone is not easily taken out from the earphone case. During clasping of the earphone opening and closing component 11 and the earphone placement component 12, the earphone opening and closing component 11 and the earphone placement component 12 can be positioned and limited by the insertion block 1121 and the insertion slot 1221, so that the earphone opening and closing component 11 and the earphone placement component 12 can be clasped with each other accurately. After the earphone opening and closing component 11 and the earphone placement component 12 are clasped, the earphone opening and closing component 11 and the earphone placement component 12 can be clasped tightly through the attractive force between the first adsorption part 131 and the second adsorption part 132.

Further, the battery assembly includes a first case cover 31, a second case cover 32, and a connection plate 33 configured for connecting the first case cover 31 with the second case cover 32. The first case cover 31 is sleeved on the outer surface of the earphone opening and closing component 11, while the second case cover 32 is sleeved on the outer surface of the earphone placement component 12. Specifically, the second case cover 32 covers the whole outer surface of the earphone placement component 12, to reduce the damage risk of the earphone placement component 12. The first case cover 31 covers the top half of the earphone opening and closing component 11, to reduce the damage risk of the earphone opening and closing component 11. The connection plate 33 is configured to connect the first case cover 31 with the second case cover 32, wherein the connection plate is rotatably connected with the first case cover 31, so that the user can open the earphone opening and closing component 11 along the side with the connection plate 33 without separating the earphone opening and closing component 11 from the earphone placement component 12 completely, to prevent one of the earphone opening and closing component 11 and the earphone placement component 12 from loss tendency due to their separation.

### Embodiment 2

Referring to FIG. 2, the technical features of the present embodiment that is distinguishable from the prior art, or the newly added technical features based on embodiment 1 of the present embodiment are: the earphone assembly also includes a first battery 113, a second battery 123, an earphone charging mechanism 124, and a conductive part 14. The first battery 113 is arranged in the earphone opening and closing component 11, the second battery 123 and the earphone charging mechanism 124 are arranged in the earphone placement component 12, and the earphone charging mechanism 124 is located at the bottom of the second earphone slot 1222. The earphone charging mechanism 124 is electrically connected to the second battery 123, while the conductive part 14 is configured to electrically connect the second battery 123 and the first battery 113. The second battery 123 and the first battery 113 are both batteries that can be charged and discharged multiple times, rather than disposable batteries. Preferably, the second battery 123 is electrically connected to the first battery 113 in parallel.

The second battery 123 is arranged in the earphone placement component 12 while the first battery 113 is arranged in the earphone opening and closing component 11, and the second battery 123 and the first battery 113 are electrically conductive through the conductive part 14, such that dual battery storage is provided to the earphone case 10, which improves the endurance of the earphone assembly.

The earphone placement component 12 and the earphone opening and closing component 11 are both triangular in shape, wherein the second battery 123 is arranged close to a corner within the earphone placement component 12 while the first battery 113 is arranged close to another corner of the earphone opening and closing component 11 which is relatively far away from the corner. Specifically, the second battery 123 is so positioned, that the second earphone slot 1222 has a relatively larger space, and the first battery 113 is so positioned, that the first earphone slot 1122 has a relatively larger space.

The second battery 123 and the first battery 113 are arranged at the corners of the earphone placement component 12 and the earphone opening and closing component 11 that are far away from each other, while the cavity formed by the second earphone slot 1222 in cooperation with the first earphone slot 1122 is located between the second battery 123 and the first battery 113. Such a space planning improves the space utilization inside the earphone case. A dual-battery earphone case with the smallest volume can be manufactured, solving the problem that the dual-battery earphone case is too large and inconvenient to carry.

The conductive parts 14 extends through the first adsorption part 131 and the second adsorption part 132, such that the structure inside the earphone case 10 is designed more compactly, so as to maximize the space utilization, further reducing the size of the earphone case 10.

The earphone charging mechanism 124 is configured in form of a round cylinder, which is adapted to the round charging interface of the earphone 20. One end of the earphone charging mechanism 124 is electrically connected to the second battery 123, while the opposite other end is arranged in the second earphone slot 1222 through the bottom of the second earphone slot 1222. The second battery 123 and the first battery 113 are capable of charging an earphone with low battery through the earphone charging mechanism 124.

Further, the end of the earphone charging mechanism 124 near the earphone is provided with a protective ring 125. Specifically, the protective ring 125 is shaped to fit the earphone charging mechanism 124. The protective ring 125 is made of metal, which can protect the earphone charging mechanism 124, such that the earphone charging mechanism 124 is more durable, the earphone 20 can contact the earphone charging mechanism 124 tightly, which improve the electrical conductivity between the earphone 20 and the earphone charging mechanism 124.

Further, the portion of the earphone slotted shell 122 below the second earphone slot 1222 is fastened with a third adsorption part 126 for improving the stability of the earphone 20 in the second earphone slot 1222. The third adsorption part 126 as a whole is configured in form of a flat cylinder. When the earphone 20 is placed in the earphone case 10 for charging, the third adsorption part 126 in the earphone slotted shell 122 may generate an adsorption effect on the earphone 20, which improves the stability of the earphone 20 in the earphone case 10, such that the earphone 20 can contact the earphone charging mechanism 124 tightly to close the circuit, so as to charge the earphone. This effectively prevents the earphone 20 from falling out of the second earphone slot 1222 during opening the earphone opening and closing component 11.

Moreover, the outer surface of the earphone opening and closing component 11 near the earphone placement component 12 is provided with an observation zone 1111. Specifically, the material of the first protective housing 111 in the observation zone 1111 is transparent. The user can observe the status of the earphone 20 inside the earphone case 10 through the observation zone 1111 without opening the earphone opening and closing component 11, reducing the loss risk of the earphone; meanwhile, the user can check the charging status of the earphone 20 in real time, to judge whether the earphone is charged normally and whether it is fully charged.

The earphone opening and closing component 11 is provided with a case charging port 1112, the case charging port 1112 is electrically connected to the first battery 113. The case charging port 1112 is configured to electrically connect the first battery 113 to an external power supply. Specifically, when the earphone case 10 is out of power, the second battery 123 and the first battery 113 of the earphone case can be charged through the case charging port 1112, to refill the earphone case 10 with energy at any time.

### Embodiment 3

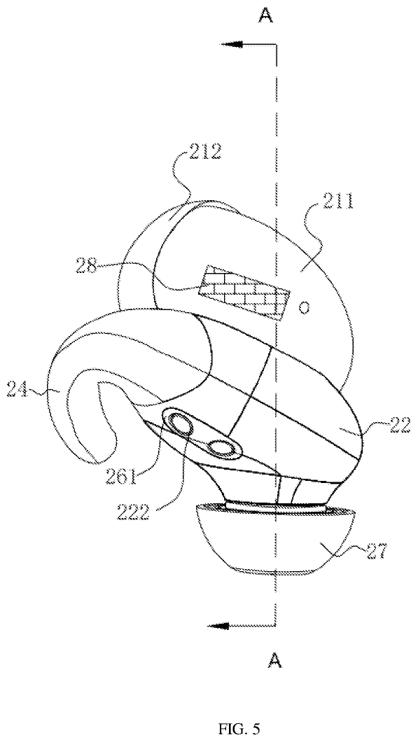

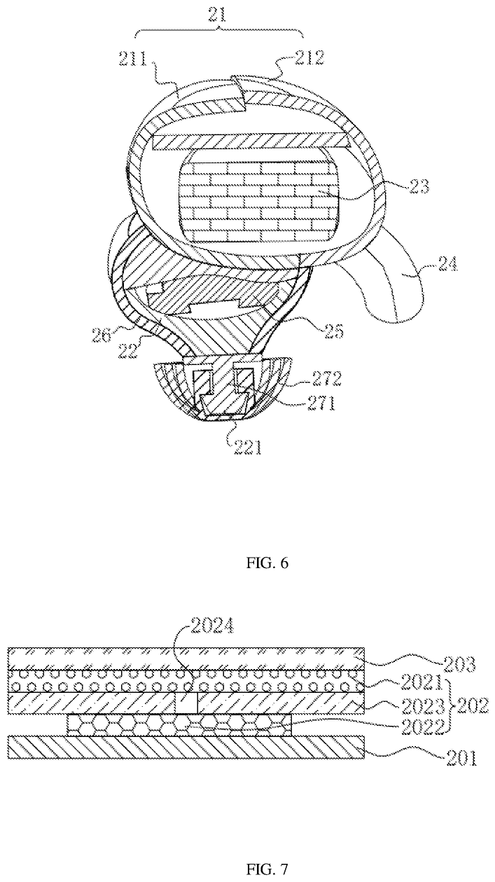

Referring to FIG. 5 and FIG. 6, the technical features of the present embodiment that are distinguishable from the prior art, or the newly added technical features based on embodiment 1 and embodiment 2 of the present embodiment are: the earphone 20 includes a first case 21 and a second case 22, the second case 22 is partially embedded and arranged at the first case 21, and the second case 22 is shaped and sized to fit into an ear. The second case 22 is provided with an elastic supporter 24, the elastic supporter 24 extends towards outside of the second case 22. The elastic supporter 24 is configured to fit into the ear arc, to prevent the earphone from falling off the ear, so that the earphone can be worn stably on the ear.

The first case 21 is larger than the second case 22. A wearer can grasp the first case 21 to wear the earphone onto the ear. The second case 22 fits into the inner arc of the ear, wherein the relatively larger first case 21 is convenient for the wearer to pick up the earphone 20 to wear.

The first case 21 is configured to accommodate the power supply component 23 of the earphone 20, and the second case 22 is configured to accommodate the transducer component 25 of the earphone 20. Specifically, the power supply component 23 can provide electrical energy to the earphone 20 so that the earphone 20 works normally, while the transducer component 25 can convert the electrical signal into sound waves to be transmitted to outside.

A side of the second case 22 away from the first case 21 is provided with a sound hole 221, so that sound in the earphone 20 can be transmitted to outside through the sound hole 221. Sound can be clearly transmitted to the ear through the sound hole 221, which improves the tone quality of the earphone.

An end of the elastic supporter 24 away from the second case 22 extends gradually close to the sound hole 221, so that the elastic supporter 24 is more firmly clamped to the ear, further improving the stability of the earphones on the ear and providing a better experience for the wearer.

The elastic supporter 24 is arc-shaped and similar to the auricle shape, so that the elastic supporter 24 can be stuck in the auricle, such that the contact area between the whole earphone and the ear is increased, thereby increasing the friction between the earphone and the ear, so that the earphone can be more securely stuck on the ear.

The elastic supporter 24 is elastically deformable to fit into different ear shapes. Everyone's ear shape is more or less different. The elastic supporter 24 of the present disclosure can change the curved shape to fit into different ear shapes through its elastic deformation, which improves the universality of the earphone and further fasten the earphone on the ear, such that the earphone is not easily detached from the ear.

The material of the elastic supporter 24 can be a polyester material with high elasticity. The polyester material with high elasticity has good resilience. The soft resilient elastic supporter 24 can fit better with the ear and has better tactile, so that the user wouldn't get pain in the ear even if he wears earphone for a long time, and the ear is not easy to be damaged. The material of the elastic supporter 24 is not limited to the polyester material with high elasticity. The skilled person in the art can also choose other materials for the elastic supporter 24, such as silicone material, wax, low-pressure foam molding compound, etc., as needed.

The sound insulation layer 26 is arranged on the surface of the second case 22 to reduce sound transmission. Specifically, the sound insulation layer 26 completely covers the surface of the second case 22, such that the earphone sound transmitted to outside is reduced, thereby improving the clarity of the earphones sound into the ear. At the same time, the sound insulation layer can also reduce noise, to reduce noise entering into the ear, so that the wearer can hear the earphone sound more clearly, so that the volume of the earphone can be lowered, in order to have a good experience while protecting the audition from not being damaged.

The sound insulation layer 26 and the elastic supporter 24 can be formed integrally. The integrated sound insulation layer 26 and elastic supporter 24 can improve the sound insulation effect of the sound insulation layer 26, meanwhile the elastic supporter 24 is more stable, and the ear comfortability is improved by the fit curvature with the ear.

The material of the sound insulation layer 26 is identical with the material of the elastic supporter 24. It also has a good sound insulation due to the high density of the polyester material with high elasticity. The sound insulation layer 26 made of polyester material with high elasticity has a better sound insulation effect, further reducing the sound transmission, maximizing sound transmission from the earphone to the ear and reducing sound transmission from outside to the ear.

The sound insulation layer 26 fits the ear, while the sound insulation layer 26 made of polyester material with high elasticity feels soft, so the sound insulation layer 26 doesn't tend to damage the ear. A soft earphone is more comfortable to wear, to bring the wearer a better experience.

The sound insulation layer 26 is detachably sleeved on the outer surface of the second case 22, which can provide the user with a variety of options to meet the requirements of various users.

The sound insulation layer 26 is provided with a charging avoidance hole 261 exposed for a charging contact 222 of the earphone 20. The charging contact 222 is electrically connected to the power supply component 23 to charge the earphone.

The earphone 20 also includes an ear plug 27 for attenuating the transmission of the earphone sound to outside. Specifically, the ear plug 27 includes a sound tube 271. A sound insulation sleeve 272 is arranged around the periphery of the sound tube 271. The sound insulation sleeve 272 is sheathed on the sound hole 221 through the sound tube 271. The sound insulation sleeve 272 can insulate sound, such that the transmission of sound to outside can be reduced by the ear plug 27, meanwhile the transmission of the external sound into the ear can be reduced, thereby noise is further reduced, so as to reduce the volume of the earphone when using, to protect the audition from not being damaged.

It is provided with at least two layers of the sound insulation sleeves 272, wherein there is a gap between adjacent sound insulation sleeves 272. It is provided with three layers of the sound insulation sleeves 272 by the present application, which can further improve the sound insulation and noise reduction effect of the earphone. A person skilled in the art can adjust the number of the layers of the sound insulation sleeve 272 to be one or two according to the production requirements.

The radius of the sound insulation sleeve 272 increases along a direction away from the sound hole 221, such that the ear plug 27 is umbrella-shaped. An umbrella-shaped ear plug 27 can be adapted to different sizes of ear canals. If the ear canal is smaller, the smallest end of the ear plug 27 can be fitted into the ear canals. If the ear canal is relative larger, the larger end of the ear plug 27 can be pushed into the ear canal. So the ear plug 27 can be fitted into the ear canal optimally regardless of the size of the ear canal, thereby not only the tone quality of the earphone is improved, but also the earphone can be worn on the ear more stably.

The ear plug 27 is smaller than the second case 22, such that the ear plug 27 can be fitted into the inner ear canal, while the relative larger second case 22 can be fitted into the outer ear canal which is relatively far from the inner ear canal, increasing the contact area of the earphone and the ear, such that the friction is increased, which improves the stability of the earphone worn on the ear, and improves the wearing comfortability.

The ear plug 27 has an audio outlet, to prevent that the sound quality is weakened by the ear plug 27. The sound from the acoustic generator can be clearly transmitted into the ear through the audio outlet, to improve the tone quality of the earphone.

The first case 21 and the second case 22 are produced in a single molding method. The person skilled in the art can also produce them in separated injection molding processes according to actual production needs.

A side of the first case 21 away from the second case 22 is provided with a first identification zone 211 and a second identification zone 212. There is a height difference between the first identification zone 211 and the second identification zone 212. When wearing the earphone, the first case 21 is usually grasped, to put the earphone into the ear, wherein the height difference between the first identification zone 211 and the second identification zone 212 can provide the wearer with a good feel, so that the wearer gets a comfortable experience.

The second identification zone 212 protrudes from the first identification zone 211, and the surface of the first identification zone 211 is provided with a logo display part 28. The earphone is more unique and is distinguishable from other earphones through the logo display part 28. The person skilled in the art can design the logo display part 28 in the form of letter pattern, brand logo, etc. according to the actual production requirements unlimitedly. The logo display part 28 can be a two-dimensional pattern or a three-dimensional pattern.

Two parts of the combined first case 21 are made of two different materials, the material combination of the two parts is plastic and metal. The person skilled in the art can use the material combination of the two parts of silicone and plastic, silicone and rubber, etc. according to the production requirements.

The colors of the two parts of the first case 21 are also different, the color combination is black and white. The person skilled in the art can use the color combination of red and white according to the production requirements.

The surfaces of the first case 21 and the second case 22 are configured as a smooth surface respectively. A frosted surface and three-dimensional texture etc. can also be applied.

The person skilled in the art can adjust the above material combination, color combination and the surface of the case according to the actual production requirements.

### Embodiment 4

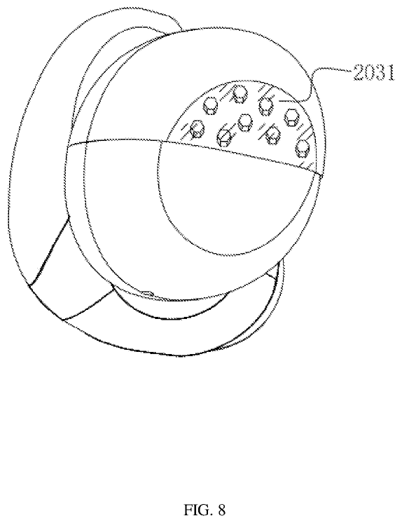

Referring to FIG. 5, FIG. 7 and FIG. 8, the technical features of the present embodiment that are distinguishable from the prior art, or the newly added technical features based on embodiment 1, embodiment 2 and embodiment 3 of the present embodiment are: the case film structure of the earphone includes a surface layer 201, a pattern layer 202 and a protective layer 203. The surface layer 201 can provide a base for printing pattern and manufacturing texture, such that the earphone can present a better visual effect, thereby improving the user experience. The pattern layer 202 is arranged on the surface layer 201, wherein the pattern layer 202 can be a pattern or a three-dimensional texture for identification, providing a color decoration for the surface layer 201, such that the visual effect of the surface layer 201 is better. The pattern of the pattern layer 202 can be attached to the surface layer 201 by spraying, etc. The case film structure includes the film structure(s) of the first case 21 and/or the second case.

The protective layer 203 covers the pattern layer 202, wherein the protective layer 203 has a transparent zone 2031, such that the pattern layer 202 covered below the protective layer 203 can be presented through the transparent zone 2031, such that the requirement on visual effect of the user can be fulfilled while the pattern layer 202 can be protected from damage by the protective layer 203, thus preventing the pattern layer 202 from being mottled by fading due to friction. The three-dimensional texture of the pattern layer 202 can also be prevented from directly contacting with the ear, which results in uncomforting of the user when wearing the earphone. The protective layer 203 covering the upper side of the pattern layer 202 directly contacts the ear, the fit with the internal shape of the ear is higher, thus improving the comfortability of the user when wearing the earphone.

The pattern layer 202 can be in various forms such as a two-dimensional and three-dimensional texture. Specifically, the pattern layer 202 can be designed as a pattern, a marbling, scrub, lacquered surface, etc. The person skilled in the art can design the style of the pattern layer 202 according to the actual production requirements unlimitedly.

The pattern layer 202 is a three-dimensional texture, or has a reflective portion. Specifically, the visual effect of the pattern layer 202 as a three-dimensional texture is more unique. The reflective portion of the pattern layer 202 can play the role of warning and marking. The reflective portion is line-shaped, sheet-shaped or mesh-shaped. Various shapes of reflective portions are provided for the producer to choose according to the production needs. The earphone is easy to detect in time due to the reflective portion when there is no enough light.

The protective layer 203 can cover the pattern layer 202 by injection molding. An injection molding process is more simple and efficient, thereby improving the production efficiency of the earphone products.

The material of the protective layer 203 can be PMMA, glass, transparent plastic, etc. The protective layer 203 can be designed to colorless transparent or colored transparent. Further, the entire protective layer 203 can be the transparent zone 2031.

The pattern layer 202 includes a circuit layer 2021 for providing power to the earphone 20. Specifically, the circuit layer 2021 is arranged between the surface layer 201 and the protective layer 203. The circuit layer 2021, originally arranged inside the earphone 20 case, is arranged on the surface layer 201 of the case, and the circuit layer 2021 is covered with a protective layer 203 for fixing and protecting the circuit layer 2021. The available space inside the earphone 20 is increased, and the designer can design the outline of the case without being limited by the circuit layer 2021 inside the case. The adjustable range of the overall shape of the earphone is increased, such that the volume and shape of the earphone can be designed, which fit more closely with the shape inside the ear.

The circuit layer 2021, originally arranged inside the earphone 20 case, tends to shake in the cavity inside the earphone, causing damage of the circuit layer 2021 and eventually shortened life of the earphone. However, the circuit layer 2021 of the earphone of the present application is arranged between the surface layer 201 and the protective layer 203, to further fasten the circuit layer 2021 and reduce the shaking of the circuit layer 2021, so that the circuit layer 2021 is not prone to be damaged, thus prolonging the service life of the earphone.

The circuit layer 2021 can be a PCB circuit board, or also a FPC circuit board. A FPC circuit board can be classified into single-layer FPC circuit board, double-layer FPC circuit board, multi-layer FPC circuit board. Compared to a PCB circuit board, a FPC circuit board has advantages of other types of circuit boards such as high wiring density, light weight, thin thickness, foldable and bendable, three-dimensional wiring etc.

The circuit layer 2021 can also be a LDS three-dimensional circuit (LDS: laser direct structure), which is a circuit manufactured by a 3D-MID (Three-dimensional molded interconnect device) technology, such a technology is a combination of injection molding, laser processing and electroplating process. The person skilled in the art can choose an appropriate circuit board according to the actual production requirements.

The pattern layer 202 also includes a light-emitting component 2022. Specifically, the light-emitting component 2022 is electrically connected with the circuit layer 2021, which provides power to the light-emitting component 2022 so that the light-emitting component 2022 can emit light. The earphone is more colorful through the amount of light emitted by the light-emitting component 2022, which improves the user's experience.

The light-emitting component 2022 can also be configured to detect whether the circuit layer 2021 works normally. If the light-emitting component 2022 gives out light normally, it means that the circuit layer 2021 is fine and undamaged. If the light-emitting component 2022 doesn't give out light, it means that the circuit layer 2021 is damaged and can't work properly when the damage to the light-emitting component 2022 itself is excluded. When the earphone can't be used normally, the user can determine whether the circuit layer 2021 is defect through the light-emitting component 2022, to determine the damaged part in time, which is convenient to repair.

The light-emitting component 2022 is arranged on a side of the circuit layer 2021 near the surface layer 201, so that the light can illuminate the circuit layer 2021, thereby the texture of the circuit layer 2021 is clearer under the illumination of the light, thus the earphone is more unique in appearance and gives the user a good experience. The light first penetrates the circuit layer 2021 and then is projected out of the protective layer 203, such that the light projected out of the protective layer 203 is reduced, thereby making the light out of the protective layer 203 more soft.

The pattern layer 202 also includes a light barrier 2023 for shielding the light emitted by the light-emitting component 2022. Specifically, the light barrier 2023 is arranged between the circuit layer 2021 and the light-emitting component 2022. The light-emitting component 2022, the light barrier 2023 and the circuit layer 2021 are arranged sequentially from inside to outside at the first case 21 and/or the second case 22. The light barrier 2023 is provided with a light passage hole 2024 for projection of a part of the light. The light barrier 2023 with the light passage hole 2024 can shield a part of the light of the light-emitting component 2022, to reduce the brightness of the light-emitting component 2022, and further to make the light projected out of the circuit layer 2021 softer and not harsh.

The light passage hole 2024 is arranged corresponding to the light-emitting component 2022, so that the light projected by the light-emitting component 2022 is soft and concentrated, thereby the earphone 20 presents a more unique visual effect.

The case is integrally formed. Specifically, the case is integrally molded with IML (In Molding Label), which prevents the pattern layer 202 of the earphone from being rubbed and scratched, which results in discoloration and mottling, such that the color of the earphone is maintained for a long time without fading and mottling, and the earphone is as new as ever in appearance after a long time of use. The integrally formed case simplifies the production process, shortens the manufacturing cycle of the earphone and improves the production efficiency of the earphone.

The case is manufactured with IMD process, wherein the surface layer 201, the pattern layer 202 and the protective layer 203 are placed into the mold in different forms, such that a molding with printed texture is obtained after injection molding. The relevant technical person in the art can also choose glue and other ways to connect the layers according to the actual production requirements.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. An earphone assembly, comprising: an earphone case, wherein the earphone case comprises an earphone opening and closing component, an earphone placement component and a connection component,
the earphone opening and closing component and the earphone placement component are detachably connected by the connection component.

2. The earphone assembly according to claim 1, wherein the connection component comprises an insertion block and an insertion slot for matching and engaging with the insertion block;
the earphone opening and closing component comprises a first protective housing and an earphone slotted plate, the earphone slotted plate is fastened with the first protective housing, the earphone slotted plate is arranged on a side at which the earphone opening and closing component abuts against the earphone placement component, and the insertion block is arranged on a side of the earphone slotted plate facing the earphone placement component;
the earphone placement component comprises a second protective housing and an earphone slotted shell, the earphone slotted shell is fixed in the second protective housing, the insertion slot is defined on a side of the earphone slotted shell facing the earphone opening and closing component.

3. The earphone assembly according to claim 2, wherein the earphone slotted plate is central symmetrical in shape, the earphone slotted plate comprises two first earphone slots for wrapping earphones, second earphone slots are provided on a side of the earphone slotted shell in engagement with the earphone slotted plate for respective mating with the two first earphone slots, the two first earphone slots are located on two sides of a symmetrical center of the earphone slotted plate.

4. The earphone assembly according to claim 2, wherein the connection component further comprises a first adsorption part and a second adsorption part, the first adsorption part and the second adsorption part have adsorption force for attracting each other, the first adsorption part is arranged in the insertion block, and the second adsorption part is arranged in the earphone slotted shell near a bottom of the insertion slot.

5. The earphone assembly according to claim 1, wherein the earphone assembly further comprises: a first case cover; a second case cover; and a connection plate for connecting the first case cover with the second case cover;
wherein the first case cover is sleeved on an outer surface of the earphone opening and closing component, and the second case cover is sleeved on an outer surface of the earphone placement component.

6. The earphone assembly according to claim 1, wherein the earphone assembly further comprises a first battery, a second battery, an earphone charging mechanism, and a conductive part;
the first battery is arranged in the earphone opening and closing component, the second battery and the earphone charging mechanism are arranged in the earphone placement component, the earphone charging mechanism is located at a bottom of each of second earphone slots, the earphone charging mechanism is electrically connected to the second battery, and the conductive part is configured to electrically connect the second battery with the first battery.

7. The earphone assembly according to claim 6, wherein the earphone placement component and the earphone opening and closing component are attracted with each other by means of a first adsorption part located within the earphone opening and closing component and a second adsorption part located within the earphone placement component;
the conductive part extends through the first adsorption part and the second adsorption part.

8. The earphone assembly according to claim 6, wherein the earphone charging mechanism is provided with a protective ring.

9. The earphone assembly according to claim 6, wherein the earphone opening and closing component is provided with a case charging port, and the case charging port is electrically connected to the first battery.

10. The earphone assembly according to claim 1, wherein an observation zone is provided on an outer surface of the earphone opening and closing component near the earphone placement component.

11. The earphone assembly according to claim 1, wherein a third adsorption part is arranged in the earphone placement component, and the third adsorption part is configured to apply an adsorption force on earphones.

12. The earphone assembly according to claim 1, wherein the earphone assembly further comprises earphones adapted to the earphone case, each of the earphones comprises:
a first case for accommodating a power supply component of the earphone;
a second case, wherein the second case is arranged on the first case and is fixedly connected with the first case and is internally communicated with the first case, an outer side of the second case is provided with an elastic supporter, the elastic supporter extends towards an outside of the second case, the elastic supporter is configured so that the elastic supporter is configured to fit an arc of an ear of a wearer; the second case is configured to accommodate a transducer component of the earphones, a side of the second case away from the first case is provided with a sound hole.

13. The earphone assembly according to claim 12, wherein an outer surface of the second case is covered with a sound insulation layer, and the sound insulation layer is detachably sleeved on the outer surface of the second case.

14. The earphone assembly according to claim 13, wherein the sound insulation layer is integrally formed with the elastic supporter.

15. The earphone assembly according to claim 12, wherein the sound hole is sleeved with an ear plug, the ear plug comprises a sound tube, the sound tube is sleeved on a periphery of the second case corresponding to the sound tube, at least two layers of sound insulation sleeves are arranged around a periphery of the sound tube, a radius of each of the at least two layers of sound insulation sleeves increases in a direction of the sound hole toward the first case, and there is a gap between adjacent layers of the at least two layers of sound insulation sleeves.

16. The earphone assembly according to claim 12, wherein a side of the first case away from the second case is provided with a first identification zone and a second identification zone, the second identification zone protrudes from the first identification zone, and a surface of the first identification zone is provided with a logo display part.

17. The earphone assembly according to claim 1, wherein the earphone assembly further comprises earphones adapted to the earphone case, a case film structure of each of the earphones comprises a surface layer, a pattern layer and a protective layer, the surface layer is configured so that the surface layer is configured to provide a base for the pattern layer, the pattern layer is arranged on the surface layer, the protective layer has a transparent zone, and the protective layer covers the pattern layer.

18. The earphone assembly according to claim 17, wherein the pattern layer comprises a circuit layer, the circuit layer is arranged between the surface layer and the protective layer.

19. The earphone assembly according to claim 18, wherein the pattern layer further comprises a light-emitting component, the light-emitting component is electrically connected to the circuit layer, the light-emitting component is arranged on a side of the circuit layer near the surface layer.

20. The earphone assembly according to claim 19, wherein the pattern layer further comprises a light barrier, the light barrier is arranged between the circuit layer and the light-emitting component, the light barrier is provided with a light passage hole corresponding to the light-emitting component.
